(19) United States
(12) Patent Application Publication
(10) Pub. No.: US 2014/0230598 A1
(43) Pub. Date: Aug. 21, 2014

(54) Brake adapter

(71) Applicant: Tektro Technology Corporation, Changhua (TW)

(72) Inventor: Szu-Fang Tsai, Changhua (TW)

(73) Assignee: Tektro Technology Corporation, Changhua (TW)

(21) Appl. No.: 14/265,279

(22) Filed: Apr. 29, 2014

(51) Int. Cl. F16C 1/20; B62L 1/14

(52) U.S. Cl. CPC F16C 1/205; B62L 1/14
USPC 74/502.3

(57) ABSTRACT

A brake adapter for a bicycle brake is provided with a bent, rigid tube including a plurality of transverse holes communicating with interior of the bent, rigid tube; and a plurality of rollers rotatably disposed in the transverse holes respectively. Both ends of each transverse hole are smaller than both ends of each roller respectively.

### BACKGROUND OF THE INVENTION

1. Field of the Invention

The invention relates to bicycle brakes and more particularly to a brake adapter for a bicycle brake.

2. Description of Related Art

A conventional brake adapter is shown in FIG. 1 and includes a hollow seat 10 and a bent, rigid tube 20′. The seat 10 has a cross section of a rectangle and includes two opposite through holes 101′ at one end and an opening 102′ on the other end. The rigid tube 20′ includes a bend 201′, an outer tube 202′ at one end of the bend 201′, a stepped-diameter sleeve 203′ at the other end of the bend 201′ and positioned at the opening 102′, and an inner tube 204′ in the outer tube 202′.

In assembly, an upper end of a brake arm is pivotably secured to the holes 101′ by a pin. A central metal wire 301′ of a brake cable 30′ passes through the all components of the rigid tube 20′ to terminate at an upper end of the other brake arm. A shield 302′ of the brake cable 30′ is disposed in the outer tube 202′.

A rider may press a brake lever to pull the metal wire 301′ of the brake cable 30′ so that the brake arms can be drawn toward each other to clamp a wheel rim, thereby braking the bicycle. However, friction between the metal wire 301′ and the bend 201′ is increased greatly and thus the rider may feel a degree of tightness on the hand. The feeling is uncomfortable and further it can decrease the braking performance.

Another conventional brake adapter is shown in FIG. 2 and includes a hollow bend 201′, and a roller 4′ partially disposed in the bend 201′. A metal wire 301′ of a brake cable passes through the bend 201′ and is in rotation contact with the metal wire 301′. This arrangement has the benefit of reducing friction when braking.

However, the roller 4′ is relatively large and is not suitable to applications of limited space and the bend having a bending angle much less than 90-degree.

Thus, the need for improvement still exists.

### SUMMARY OF THE INVENTION

It is therefore one object of the invention to provide a brake adapter comprising a bent, rigid tube including a plurality of transverse holes communicating with interior of the bent, rigid tube; and a plurality of rollers rotatably disposed in the transverse holes respectively; wherein both ends of each of the transverse holes are smaller than both ends of each of the rollers respectively.

The above and other objects, features and advantages of the invention will become apparent from the following detailed description taken with the accompanying drawings.

### BRIEF DESCRIPTION OF THE DRAWINGS

FIG. 1 is an exploded view of a conventional brake adapter;

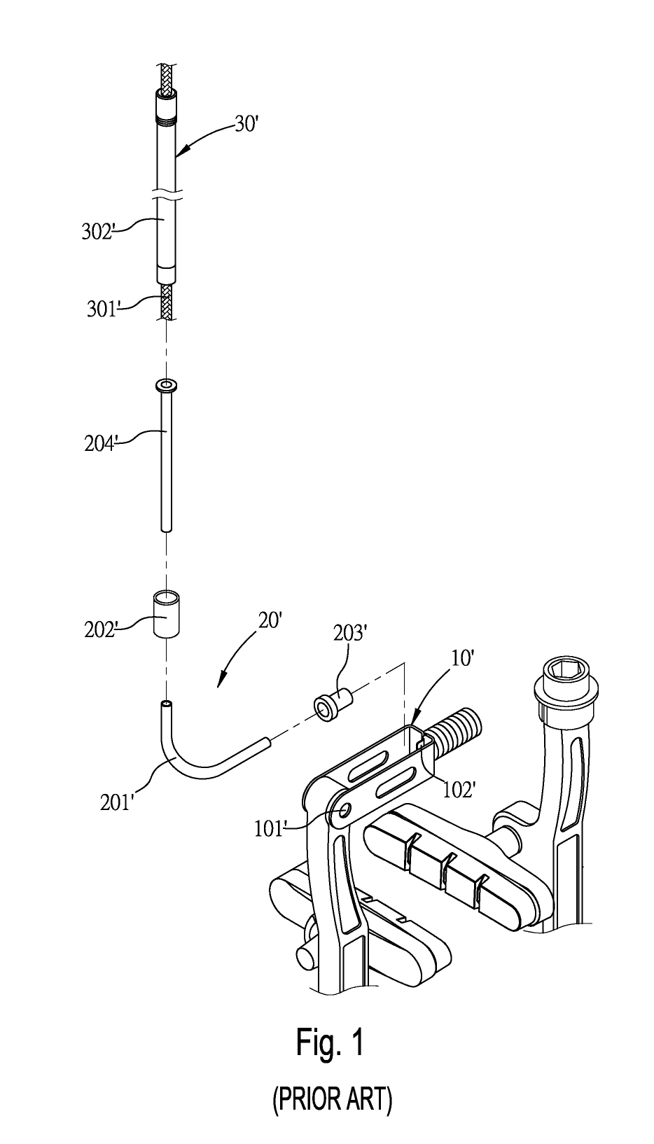

FIG. 2 is a perspective view of another conventional brake adapter;

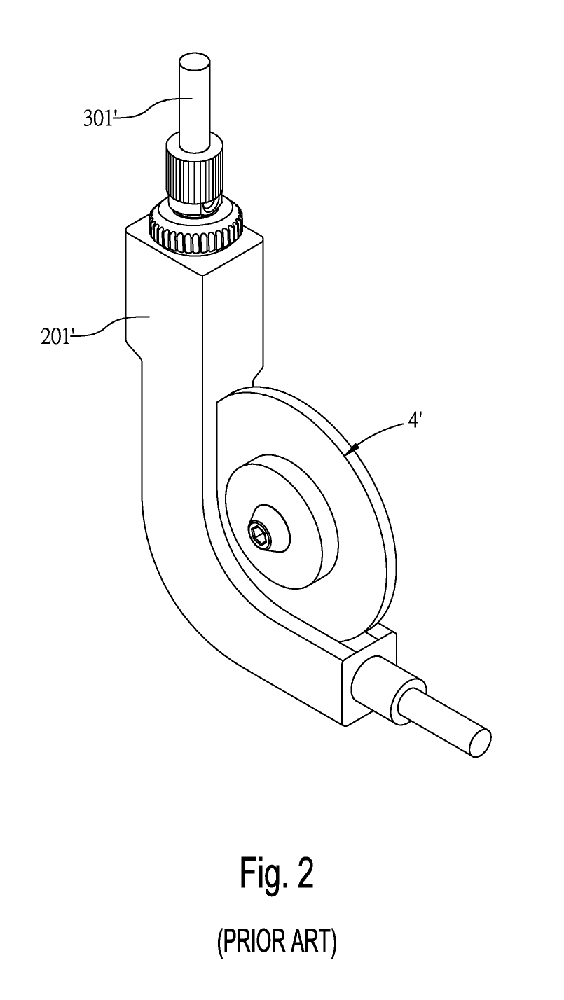

FIG. 3 is an exploded view of a brake adapter according to a first preferred embodiment of the invention;

FIG. 4 is a perspective view of the assembled brake adapter of FIG. 3;

FIG. 5 is a side elevation of the brake adapter of FIG. 4;

FIG. 6 is a longitudinal sectional view of the brake adapter of FIG. 5;

FIG. 7 is a view similar to FIG. 6 showing a pulling of the brake cable when braking;

FIG. 8 is an environmental view of the brake adapter mounted proximate to a rear derailleur of a bicycle;

FIG. 9 is a side elevation of a bicycle frame with the brake adapter mounted therein;

FIG. 10 is a perspective view of a brake adapter according to a second preferred embodiment of the invention; and

FIG. 11 is a view similar to FIG. 10 showing a brake arm pivotably secured to the bifurcation of the brake adapter.

### DETAILED DESCRIPTION OF THE INVENTION

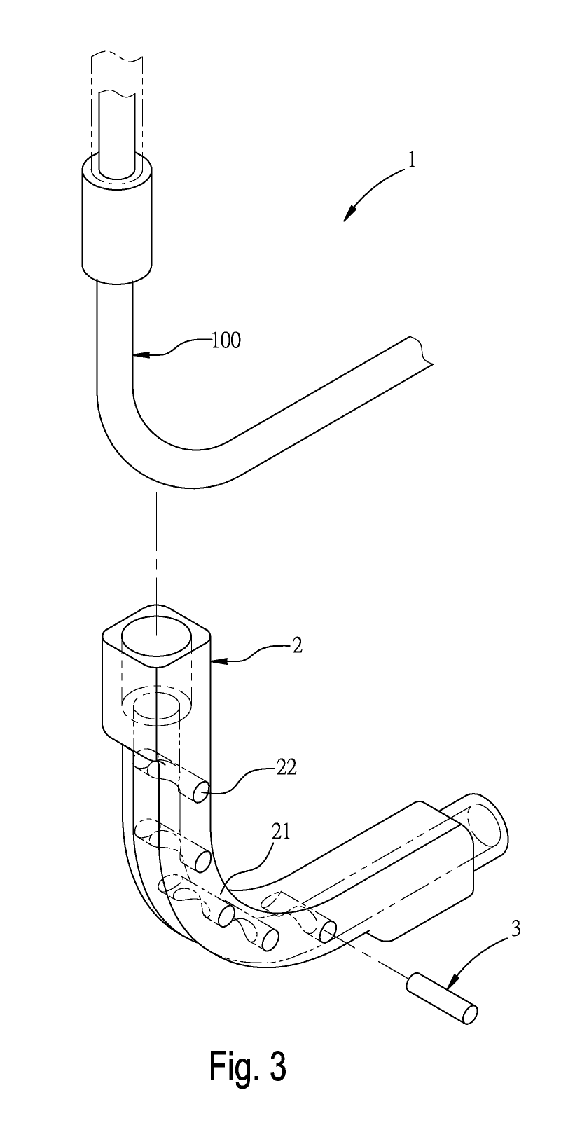

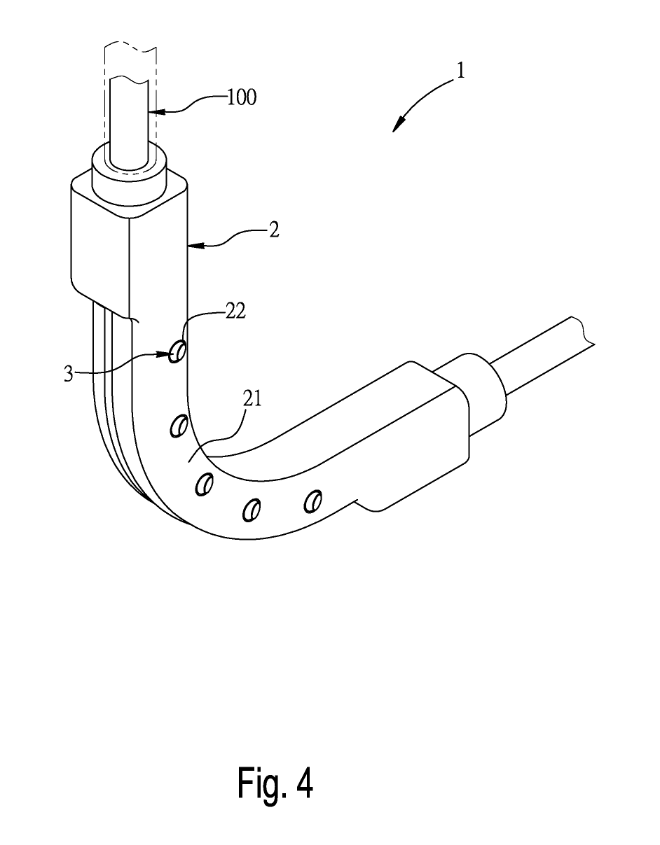

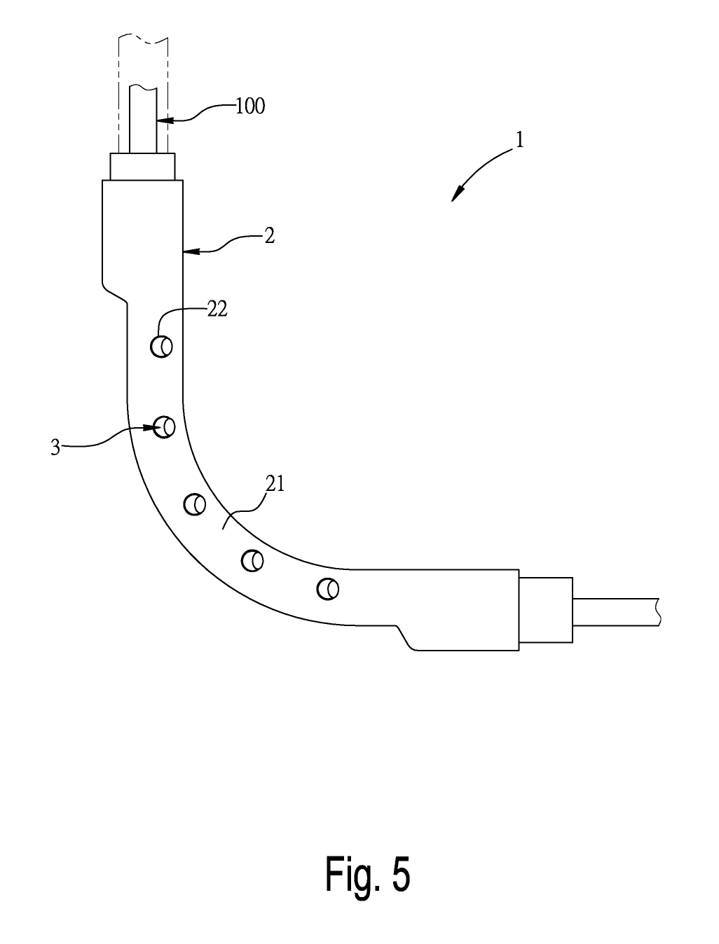

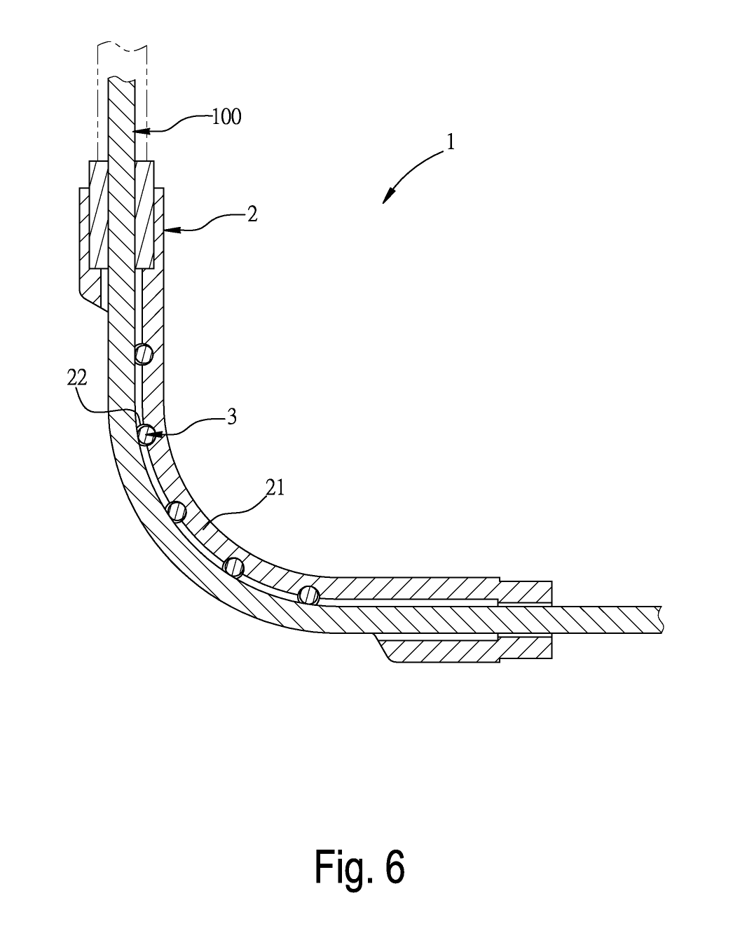

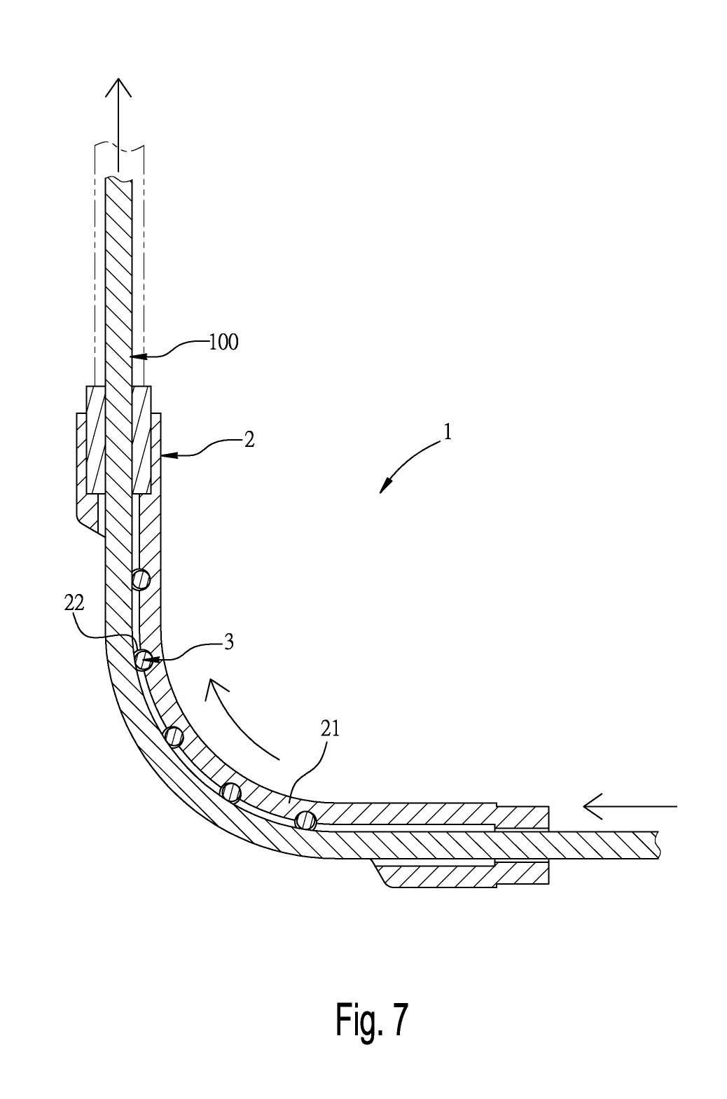

Referring to FIGS. 3 to 9, a brake adapter 1 in accordance with a first preferred embodiment of the invention comprises the following components as discussed in detail below.

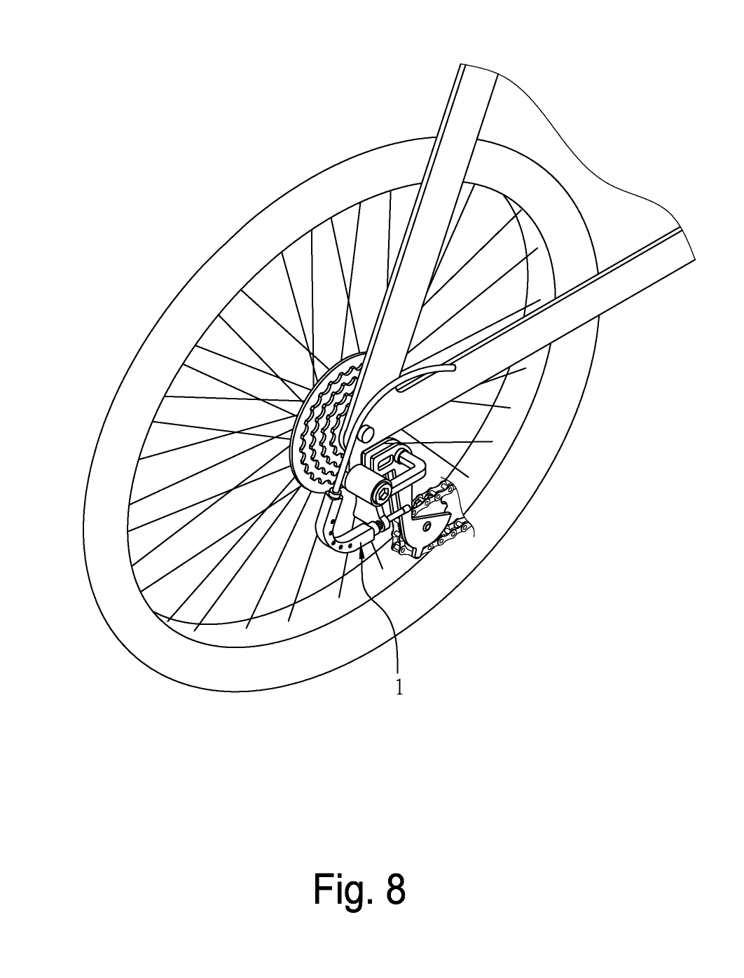

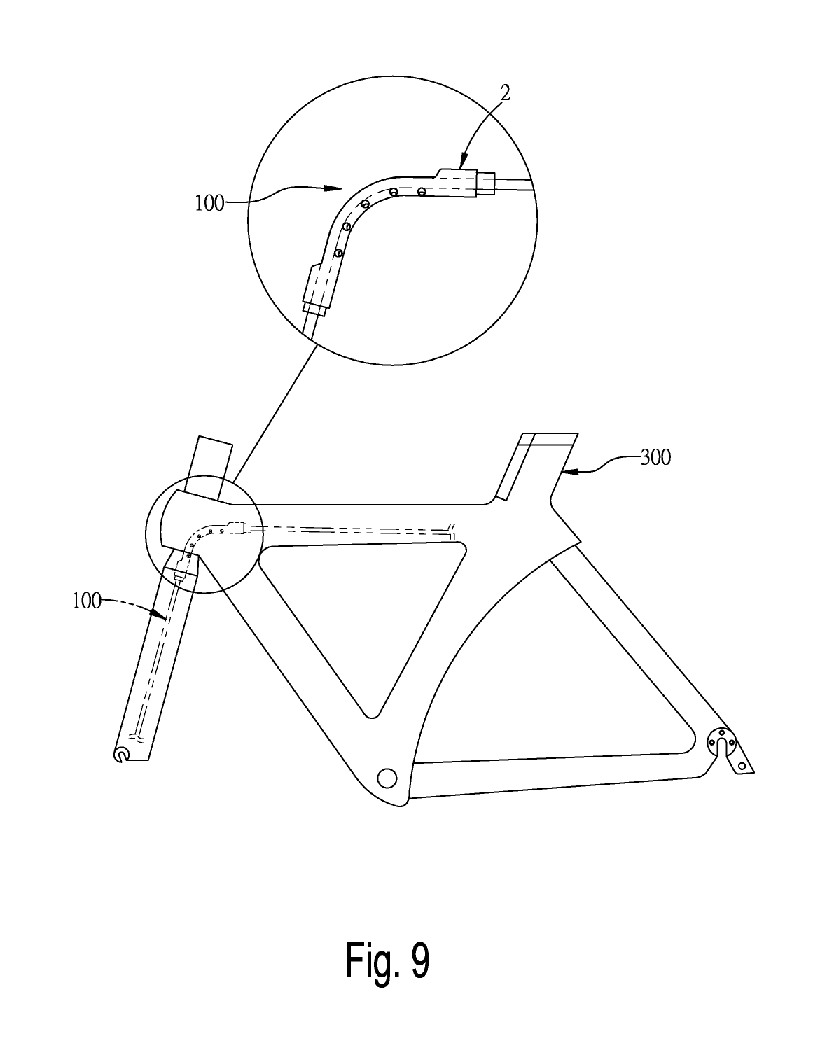

A bent, rigid tube 2 and a plurality of rollers 3 are provided. The brake adapter 1 is adapted to install, for example, in a position proximate to a rear derailleur of a bicycle (see FIG. 8) or in a frame 300 of the bicycle (see FIG. 9). The bent, rigid tube 2 is shaped as an L and includes a 90-degree bend 21 and a plurality of (five are shown) transverse holes 22 equally spaced apart, through the bend 21, and communicating with interior of the bent, rigid tube 2. The rollers 3 are disposed in the holes 22. Further, openings of each hole 22 is struck to decrease diameters thereof so that the roller 3 can freely rotate in the hole 22 without disengaging from the hole 22 at the final step of manufacturing process.

A brake cable 100 is inserted into an inlet of the bent, rigid tube 2 and leaves an outlet of the bent, rigid tube 2. The brake cable 100 is tightened when braking. Further, the brake cable 100 in the bent, rigid tube 2 contacts the rollers 3. This has the benefits of reducing friction of the brake cable 100, giving a smooth feeling to a rider when braking, and sufficiently transmitting braking force to the brake mechanism of the bicycle brake.

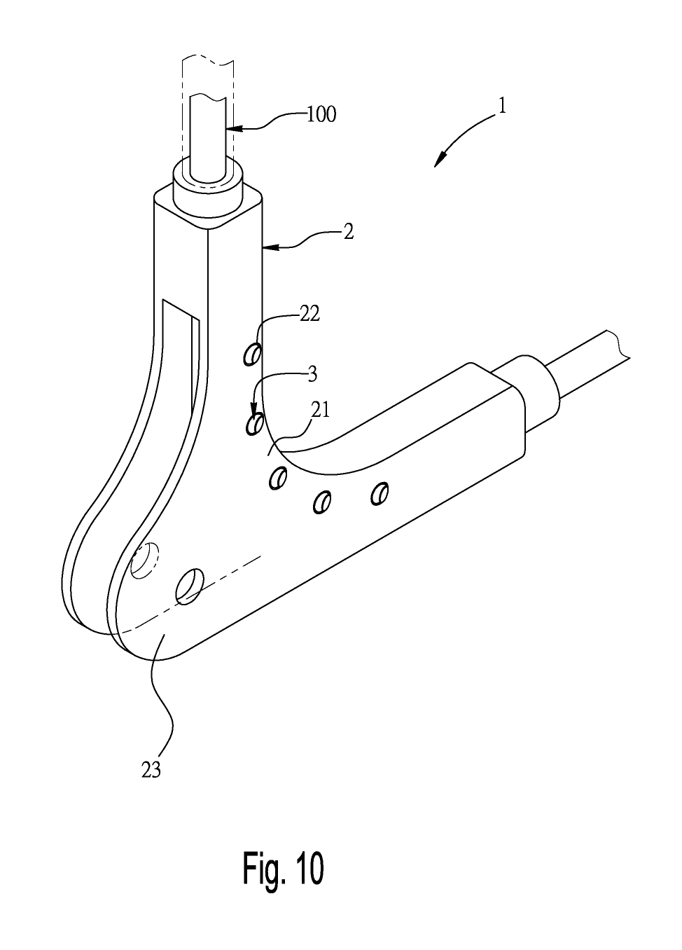

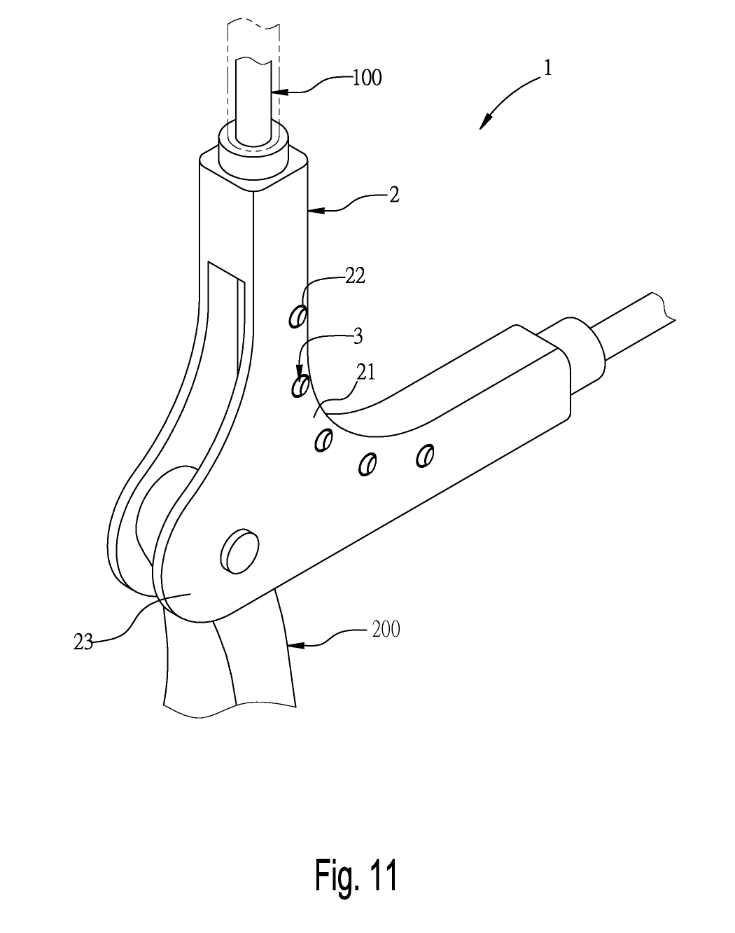

Referring to FIGS. 10 and 11, a brake adapter 1 in accordance with a second preferred embodiment of the invention is shown. The characteristics of the second preferred embodiment are substantially the same as that of the first preferred embodiment except the following: The bent, rigid tube 2 further includes a bifurcation 23. A brake arm 200 is pivotably secured to the bifurcation 23. This embodiment has the benefits of simplifying the manufacturing process and saving cost.

While the invention has been described in terms of preferred embodiments, those skilled in the art will recognize that the invention can be practiced with modifications within the spirit and scope of the appended claims.

What is claimed is:

1. A brake adapter for a bicycle brake comprising:
a bent, rigid tube including a plurality of transverse holes communicating with interior of the bent, rigid tube; and
a plurality of rollers rotatably disposed in the transverse holes respectively;
wherein both ends of each of the transverse holes are smaller than both ends of each of the rollers respectively.

2. The brake adapter of claim 1, wherein both ends of each of the transverse holes are struck to decrease diameters thereof so as to retain the rollers in the transverse holes.

3. The brake adapter of claim 1, wherein the bent, rigid tube further includes a bifurcation for pivotably securing to a brake arm.

4. A brake adapter for a bicycle brake comprising, in combination;
a bent, rigid tube including a plurality of transverse holes communicating with interior of the bent, rigid tube, and a bifurcation for pivotably securing to a brake arm; and
a plurality of rollers rotatably disposed in the transverse holes respectively;
wherein both ends of each of the transverse holes are smaller than both ends of each of the rollers respectively; and
wherein both ends of each of the transverse holes are struck to decrease diameters thereof so as to retain the rollers in the transverse holes.
